(19) United States
(12) Patent Application Publication
(10) Pub. No.: US 2026/0263964 A1
(43) Pub. Date: Sep. 10, 2026

(54) SYSTEMS AND METHODS FOR METAL RECOVERY USING ROTATING PACKED BEDS

(71) Applicants: UCHICAGO ARGONNE, LLC, Chicago, IL (US); CASE WESTERN RESERVE UNIVERSITY, Cleveland, OH (US)

(72) Inventors: Anna Gloria Servis, Naperville, IL (US); William R. Dean-Kersten, Lemont, IL (US); Christine E. Duval, Cleveland, OH (US); Kayla Kent, Cleveland, OH (US)

(73) Assignees: UCHICAGO ARGONNE, LLC, Chicago, IL (US); CASE WESTERN RESERVE UNIVERSITY, Cleveland, OH (US)

(21) Appl. No.: 19/555,332

(22) Filed: Mar. 3, 2026

Related U.S. Application Data
(60) Provisional application No. 63/766,635, filed on Mar. 4, 2025.

(51) Int. Cl. B01D 15/02; B01D 15/20; B01D 15/38; B01D 15/42; C22B 3/02; C22B 3/24; C22B 59/00

(52) U.S. Cl. CPC B01D 15/02; B01D 15/203; B01D 15/3828; B01D 15/424; C22B 3/02; C22B 3/24; C22B 59/00

(57) ABSTRACT

An assembly can include a housing. The housing can include an inlet and an outlet. The assembly can include a rotor coupled with a motor and disposed in the housing. The rotor can include an adsorbent. The rotor can be configured to rotate at a first rotational speed and at a second rotational speed different from the first rotational speed. At the first rotational speed, a first concentration of a first metal can be adsorbed onto the adsorbent and a second concentration of a second metal can be adsorbed onto the adsorbent. At the second rotational speed, a third concentration of the first metal can be adsorbed onto the adsorbent and a fourth concentration of the second metal can be adsorbed onto the adsorbent. The first concentration can be different from the third concentration and the second concentration is different from the fourth concentration.

### CROSS-REFERENCE TO RELATED APPLICATIONS

This application claims priority to U.S. Provisional Patent Application No. 63/766,635, filed on Mar. 4, 2025, which is incorporated herein by reference in its entirety for any and all purposes.

### STATEMENT OF GOVERNMENT INTEREST

This invention was made with government support under Contract No. DE-AR0001692 (WAS 22/CJ000/01/01) awarded by the United States Advanced Research Projects Agency-Energy and Contract No. DE-AC02-06CH11357 awarded by the United States Department of Energy to UChicago Argonne, LLC, operator of Argonne National Laboratory and contract No. DE-0009009 awarded by the United States Office of Nuclear Energy University Leadership Program to Case Western Reserve University. The government has certain rights in the invention.

### TECHNICAL FIELD

In some embodiments, the disclosed subject matter relates generally to metal recovery and/or separation from liquid streams.

### BACKGROUND

Packed columns can be used for liquid-solid chemical separations.

### SUMMARY

In some embodiments, compared to a stationary packed bed, the rotating packed bed (RPB) increases the metal capacity of a rare earth element-selective packing. The RPB can be used for metal processing, retrofitting existing processes, constructing mobile metal processing plants, radioisotope capture, processing and separation of nuclear waste, environmental remediation of radionuclides, processing of irradiated targets, rare earth element recovery, precious metal recovery, critical mineral recovery, and/or solar panel synthesis waste stream processing. These are non-limiting examples of applications of the RPB.

Some embodiments are directed to an assembly. The assembly can include a housing. The housing can include an inlet and an outlet. The assembly can include a rotor. The rotor can be coupled with a motor. The rotor can be disposed in the housing. The rotor can include an adsorbent. The rotor can be configured to rotate at a first rotational speed and at a second rotational speed different from the first rotational speed. At the first rotational speed, a first concentration of a first metal can be adsorbed onto the adsorbent and a second concentration of a second metal can be adsorbed onto the adsorbent. At the second rotational speed, a third concentration of the first metal can be adsorbed onto the adsorbent and a fourth concentration of the second metal can be adsorbed onto the adsorbent. The first concentration can be different from the third concentration and the second concentration can be different from the fourth concentration. In some embodiments, the rotational speed can be kept constant and the liquid can be changed. In another embodiment, the rotational speed can be changed and the liquid can be changed.

Some embodiments are directed to a method. The method can include providing a housing. The housing can include an inlet and an outlet. The method can include disposing a rotor in the housing. The rotor can include an adsorbent. The method can include coupling the rotor to motor. The method can include flowing a first liquid including a first metal and a second metal or more. The method can include rotating the rotor at a first rotational speed while flowing a first liquid through the adsorbent such that a first concentration of the first metal is adsorbed onto the adsorbent and a second concentration of the second metal is adsorbed onto the adsorbent. The method can include rotating the rotor at a second rotational speed while flowing a second liquid through the adsorbent such that a third concentration of the first metal is eluted from the adsorbent and a fourth concentration of the second metal is eluted from the adsorbent.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through the use of the accompanying drawings.

FIG. 1 illustrates a schematic diagram of an assembly, according to an example implementation.

FIG. 2 is a perspective view of the assembly, according to an example implementation.

FIG. 3 is a perspective view of a portion of the assembly, according to an example implementation.

FIG. 4 is a view of a portion of the assembly, according to an example implementation.

FIG. 5 is a bottom view of a portion of the assembly, according to an example implementation.

FIG. 6 illustrates a plot of amount of neodymium adsorbed vs. rotation speed, according to an example implementation.

FIG. 7 illustrates a plot of amount of cerium adsorbed vs. rotation speed, according to an example implementation.

FIG. 8 illustrates a plot of an elution profile of the assembly, according to an example implementation.

FIG. 9 illustrates a schematic diagram of an adsorption system, according to an example implementation.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Following below are more detailed descriptions of various concepts related to, and implementations of, methods, apparatuses, and systems for metal recovery using rotating packed beds. The various concepts introduced above and discussed in greater detail below may be implemented in any of numerous ways.

Adsorption and ion exchange can be used in chemical processing to isolate low concentration solutes from large volumes of solution by running the solution through a bed of packing that captures one or more of the dissolved components. Once the bed is saturated with the captured solutes, it may be regenerated by desorbing the solutes, which can then be eluted and recovered for further use or disposal as waste. Loading and regeneration cycles can be intermittent and can require multiple packed beds for application in continuous processes. Increasing the capacity of the adsorbent can reduce the frequency of regeneration cycles, decrease the volume of regenerant required (and thereby increase the eluent concentration), and decrease packed bed volume needed for a given throughput.

Chemical processes can use stationary beds of packing retained in large vertical vessels (e.g., packed columns,) connected in parallel. In one example, only one bed is use at a time while the other is being regenerated. The process stream can be introduced at the top of the active bed and flow downward by gravity. Once the active bed is saturated, the inlets to the two beds can be switched. This approach can be used for low-hazard streams, where the cost of building and maintaining large, stationary equipment is not prohibitive and where the final concentration of captured solute in the eluent is not important. However, the space and reagent requirements for large, stationary packed beds can deter their use in retrofit scenarios, for mobile processing of secondary metal resources, and in processes involving high hazard materials such as radioactive elements. The pressure drop can limit the throughput of packed columns.

The systems and methods of the present disclosure can include one or more rotating packed beds designed for metals processing. The rotating packed bed can increase the capacity of rare earth element-selective packing by more than two times compared to a stationary packed bed. The rotating packed bed can be used for metal processing. The rotating packed bed can be used for applications such as retrofitting existing processes (e.g., adding a metal recovery step for waste valorization to mining facilities), constructing mobile metal processing plants (e.g. for distributed magnet and battery recycling), and/or radioisotope capture (e.g. minimizing the size of a nuclear facility for recovering valuable isotopes from irradiated uranium or other targets). Compared to a packed column, the rotating packed bed can have larger capacity and smaller packed bed volume. Compared to the packed column, the rotating packed bed can be more compact and easier to position behind radiation shielding.

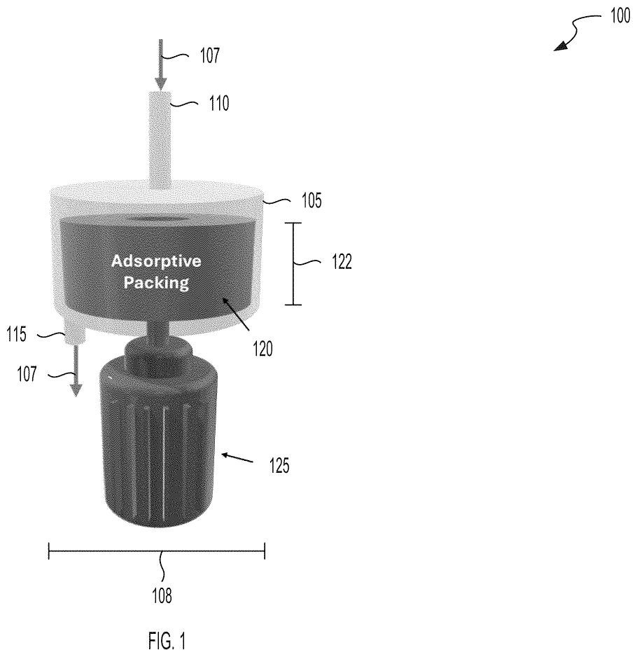

FIG. 1 illustrates a schematic diagram of an assembly 100. The assembly 100 includes a rotating packed bed or rotating packed bed contactor. Rotating packed beds can include a class of chemical process equipment for process intensification. The assembly 100 can be used for adsorption and/or ion exchange. The assembly 100 can increase the capacity (e.g., metal capacity) of rare earth element-selective packing by more than two times compared to a stationary packed bed (e.g., packed column). The assembly 100 can be smaller than the packed column. The assembly 100 can be 3D printed and/or machined (e.g., machined out of stainless steel). Non-limiting examples of applications of the assembly 100 include battery recycling and/or magnet recycling. The assembly 100 can be used for target processing in isotope production. The assembly 100 can be used for recovery of usable elements (e.g., from mining or coal combustion waste). The assembly 100 can be used for recovery of radioactive materials. The assembly 100 can be used for solid-liquid separation. The assembly 100 can be used for processing and/or separation of nuclear waste. The assembly 100 can be used for environmental remediation of radionuclides in contaminated surface water and/or groundwater. The assembly 100 can be used for processing of irradiated targets for radioisotope production. The assembly 100 can be used for rare earth element recovery from mining waste. The assembly 100 can be used for solar panel synthesis waste stream processing for tellurium (Te) recovery.

The assembly 100 can include one or more housings 105. The housing 105 can include a casing (e.g., stationary casing). In one example, the housing 105 has a cylindrical shape. The housing 105 can have a width 108 of less than 3 ft. For example, the housing 105 can have a width 108 of less than 3 ft, less than 2.5 ft, less than 2 ft, less than 1.5 ft, or less than 1 ft. In some embodiments, the housing 105 can have a width 108 of greater than or equal to 3 ft.

The housing 105 can include one or more inlets 110. The inlet 110 can be disposed at a top portion of the assembly 100. The inlet 110 can be disposed at a center of the assembly 100. The inlet 110 (e.g., liquid inlet) can receive a liquid 107. The liquid 107 can include a metal-containing stream. For example, the liquid 107 can include 3 M nitric acid (HNO₃) with 1000 ppm Nd, 600 ppm Ce, 400 ppm Mo, and 200 ppm Sr. The liquid 107 can be part of or derived from a feedstock stream. The liquid 107 can be an aqueous solution at temperatures in a range between 5° C. and 85° C. The liquid 107 can have a pH that is acidic, neutral, or basic, depending on the feedstock. The metals (e.g., metal ions) can be dissolved in the liquid 107. The liquid 107 can include a mixture of nitric acid and various metals. The liquid 107 can include a stream (e.g., process stream). The liquid 107 can include a lanthanide-containing stream. In one example, the assembly 100 can hold 100 mL to 400 mL of the liquid 107. The liquid 107 can include uranium fission products. The liquid 107 used for adsorption can be termed “adsorption liquid” or “process stream.” The liquid 107 can include a binary mixture of metals. The liquid 107 can include a mixture of metals.

The housing 105 can include one or more outlets 115. The outlet 115 can be disposed at a bottom portion of the assembly 100. The outlet 115 can be disposed at an outer edge of the assembly 100. The outlet 115 (e.g., liquid outlet) can output the liquid 107. The liquid 107 passing through the outlet 115 can be free of adsorbed metals. In some embodiments, the liquid 107 passing through the outlet 115 contains some metals.

The assembly 100 can include one or more rotors 120. The rotor 120 can be disposed in the housing 105. The rotor 120 can include an adsorbent (e.g., adsorptive packing, packing material). The adsorbent can be disposed in the rotor 120. The adsorbent can be a part of the rotor 120. The adsorbent can include a resin (e.g., adsorbent resin). For example, the adsorbent can include a rare earth-selective chromatography resin. The adsorbent can include a lanthanide-selective solid resin. The adsorbent can include a DGA resin from Eichrom®. The adsorbent can include an extraction chromatographic material. In one example, the extraction chromatographic material includes N,N,N′,N′-tetra-n-octyldiglycolamide or N,N,N′,N′-tetra-2-ethylhexyldiglycolamide. The adsorbent can have a bed density of 0.39 g/mL. The adsorbent can have a functional capacity of 7-8 mg Eu per mL of resin. The adsorbent can have a particle diameter in a range from 50 μm to 1,000 μm. The adsorbent can have an affinity for rare earth elements (e.g., trivalent rare earth elements) and actinides such as Y(III), Lu(III), Tb(III), Am(III), Cm(III), and Ac(III). Trivalent actinides and rare earths can be retained on the adsorbent from HNO₃, while Fe(III), Na(I), K(I), Mg(II) and other matrix ions can be rejected. The adsorbent can include a cross-linked polymer resin. In one example, the adsorbent selectively adsorbs one or more metals of interest. The adsorbent can be used to control the selectivity of target metals (e.g., metals of interest). In one example, when the liquid 107 used for adsorption flow through the adsorbent, target metals are deposited onto/within the adsorbent. The adsorbent can include, for example, inorganic adsorbents (e.g., silica, alumina, titania or others), polymer ion exchange resins, and/or extraction chromatographic resins.

The adsorbent is disposed in the housing 105. The adsorbent can be loaded in the assembly 100. For example, the resin can be loaded in the RPB. The adsorbent can have a height 122 of less than 1 ft. For example, the adsorbent can have a height 122 of less than 1 ft, less than 0.75 ft, or less than 0.5 ft. In some embodiments, the adsorbent can have a height 122 of greater than or equal to 1 ft. The adsorbent can be arranged in a cylindrical shape. The adsorbent can rotate with the rotor 120. The housing 105 can be shaped to conform to the shape of the adsorbent/rotor 120. In this case, the housing 105 is larger than the adsorbent/rotor 120 such that the adsorbent/rotor 120 fits into the housing 105. The shape of the housing 105 can be similar to the shape of the adsorbent/rotor 120. For example, the portion of the housing 105 that includes the adsorbent/rotor 120 is shaped as a cylinder.

The rotor 120 can rotate at a first rotational speed. The rotor 120 can rotate at a second rotational speed. The second rotational speed can be different from the first rotational speed. The second rotational speed can be less than, greater than, or equal to the first rotational speed. The rotor 120 can rotate at a third rotational speed. The third rotational speed can be different from the first rotational speed. The third rotational speed can be less than, greater than, or equal to the first rotational speed. The third rotational speed can be different from the second rotational speed. The third rotational speed can be the same as the second rotational speed. The third rotational speed can be less than, greater than, or equal to the second rotational speed. The rotational speed of the rotor 120 can be, for example, in a range between 0 rpm and 2000 rpm. When the rotor 120 rotates, the adsorbent can rotate. When the rotor 120 rotates, the liquid 107 can be moved (e.g., transported) outwards from the center of the assembly 100 to the outer portion of the assembly 100. The liquid 107 can be moved through the adsorbent. The rotational speed of the rotor 120 can be used to control the selectivity of the target metals. For example, changing the rotational speed of the rotor 120 can change the type and concentration of metals adsorbed onto the adsorbent. Changing the rotational speed of the rotor 120 can change the type and concentration of metals eluted from the adsorbent. The rotational speed of the rotor 120 for adsorption can be different from the rotational speed of the rotor 120 for elution. The rotational speed of the rotor 120 for adsorption can be less than, greater than or equal to the rotational speed of the rotor 120 for elution. The rotational speed of the rotor 120 for selectivity can vary based on the type of adsorbent, initial pH of the metal solution, and/or concentrations of the metals.

At the first rotational speed, a first concentration of a first metal can be adsorbed onto the adsorbent. The first metal can be retained on the adsorbent. At the first rotational speed, a second concentration of a second metal can be adsorbed onto the adsorbent. The second metal can be retained on the adsorbent. The adsorbent can include a cross-linked polymer resin having ligands configured to chelate the first metal and the second metal. The adsorbent can selectively adsorb one or more metals of interest through a mechanism of chelation. The first metal can include at least one of neodymium, cerium, molybdenum, or strontium. The second metal can include at least one of neodymium, cerium, molybdenum, or strontium. In some embodiments, the first metal or the second metal includes lanthanides or other critical energy metals such as tellurium, cobalt, gallium, lithium, nickel, uranium, magnesium, and aluminum, and platinum group metals (e.g., iridium, osmium palladium, platinum, rhodium, ruthenium).

At the second rotational speed, a third concentration of the first metal can be adsorbed onto the adsorbent. At the second rotational speed, a fourth concentration of the second metal can be adsorbed onto the adsorbent. The first concentration can be different from the third concentration. The second concentration can be different from the fourth concentration. The first concentration of the first metal can be different from the third concentration of the first metal. The second concentration of the second metal can be different from the fourth concentration of the second metal. The first concentration of the first metal can be less than, greater than, or equal to the third concentration of the first metal. The second concentration of the second metal can be less than, greater than, or equal to the fourth concentration of the second metal.

Further, adsorbed metals can be removed from the adsorbent. The liquid 107 can flow from the inlet 110, through the adsorbent, and to the outlet 115. The liquid 107 can elute the first metal from the adsorbent. The liquid 107 used for elution can be termed “elution liquid.” For example, the elution liquid can remove an adsorbed substance (e.g., metals) from the adsorbent. The liquid 107 can elute the second metal from the adsorbent. The pH of the liquid 107 used for elution can be different from the pH of the liquid 107 used for adsorption. The pH of the liquid 107 used for elution (e.g., elution liquid) can be less than, greater than, or equal to the pH of the liquid 107 used for adsorption (e.g., adsorption liquid, process stream). The metals can be eluted by changing the pH of the liquid 107, changing the acid type, and/or adding complexing/chelating agents (e.g., EDTA, citric acid, etc.). A combination of these techniques can be used to elute the metals.

The liquid 107 can include a first liquid having a first pH. The first liquid can include the adsorption liquid or process stream. The first liquid can flow through the adsorbent such that the first metal is adsorbed onto the adsorbent. The first liquid can flow through the adsorbent such that the second metal is adsorbed onto the adsorbent. The first liquid can flow through the adsorbent when the rotor 120 is rotating at the first rotational speed. The first liquid can flow through the adsorbent a first flow rate. The first flow rate can be higher than a flow rate through the packed column.

The liquid 107 can include a second liquid having a second pH different from the first pH. The second liquid can include the elution liquid. The second liquid can flow through the adsorbent such that the first metal is eluted from the adsorbent. The second liquid can flow through the adsorbent such that the second metal is eluted from the adsorbent. The second liquid can flow through the adsorbent when the rotor 120 is rotating at the third rotational speed. The second liquid can flow through the adsorbent when the rotor 120 is rotating at the first rotational speed. The second liquid can flow through the adsorbent at the first flow rate. The second liquid can flow through the adsorbent at a second flow rate. The second flow rate can be different from the first flow rate. The second flow rate can be less than, greater than, or equal to the first flow rate. The second flow rate can be higher than the flow rate through a packed column. The flow rate of the liquid 107 can be used to control the selectivity of the target metals. For example, changing the flow rate of the liquid 107 can change the type and concentration of metals adsorbed onto the adsorbent. Changing the flow rate of the liquid 107 can change the type and concentration of metals eluted from the adsorbent. The flow rate of the liquid 107 for adsorption can be different from the flow rate of the liquid 107 for elution. The flow rate of the liquid 107 for adsorption can be less than, greater than or equal to the flow rate of the liquid 107 for elution.

The assembly 100 can include one or more motors 125. The motor 125 can be coupled with the rotor 120. The rotor 120 can be coupled with the motor 125. The motor 125 can rotate the rotor 120. The rotor 120 can include a moving component in the motor 125.

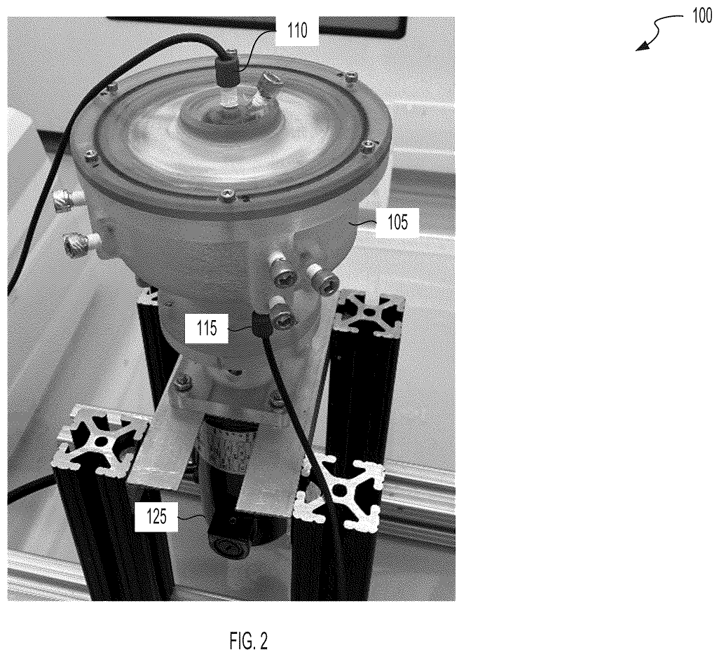

FIG. 2 is a perspective view of the assembly 100. The assembly 100 includes the housing 105, the inlet 110, the outlet 115, the motor 125. The inlet 110 is connected to a first conduit that feeds the elution liquid or the adsorption liquid into the housing 105. The outlet 115 is connected to a second conduit that removes the elution liquid or the adsorption liquid from the housing 105. The rotor 120 (not shown) is disposed in the housing 105. The rotor 120 is coupled with the motor 125. In this example, the assembly 100 is 3D printed. 3D printing the assembly 100 allows for faster prototyping and/or testing of the assembly 100.

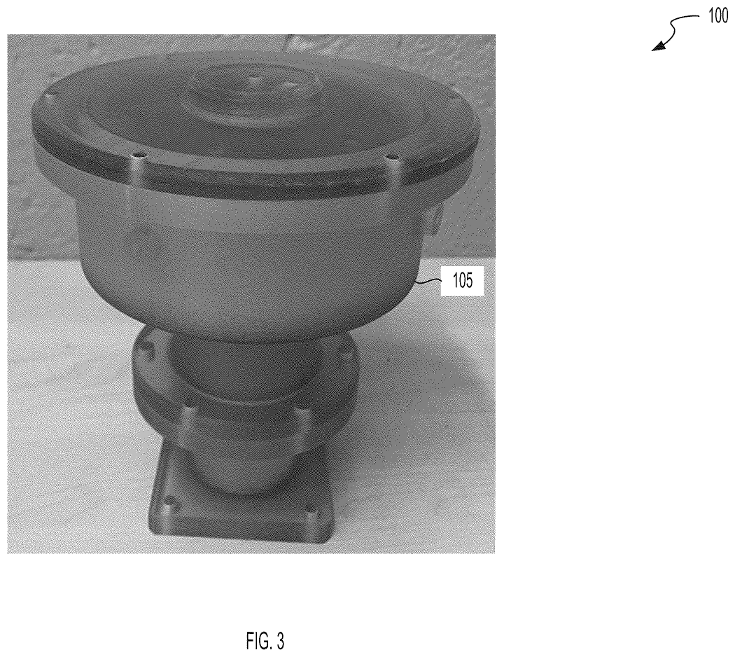

FIG. 3 is a perspective view of a portion of the assembly 100. The portion of the assembly 100 is shown without the motor 125. The assembly 100 includes the housing 105. In this example, the assembly 100 is 3D printed. In other embodiments of the assembly 100, the assembly can be machined, for example, from stainless steel.

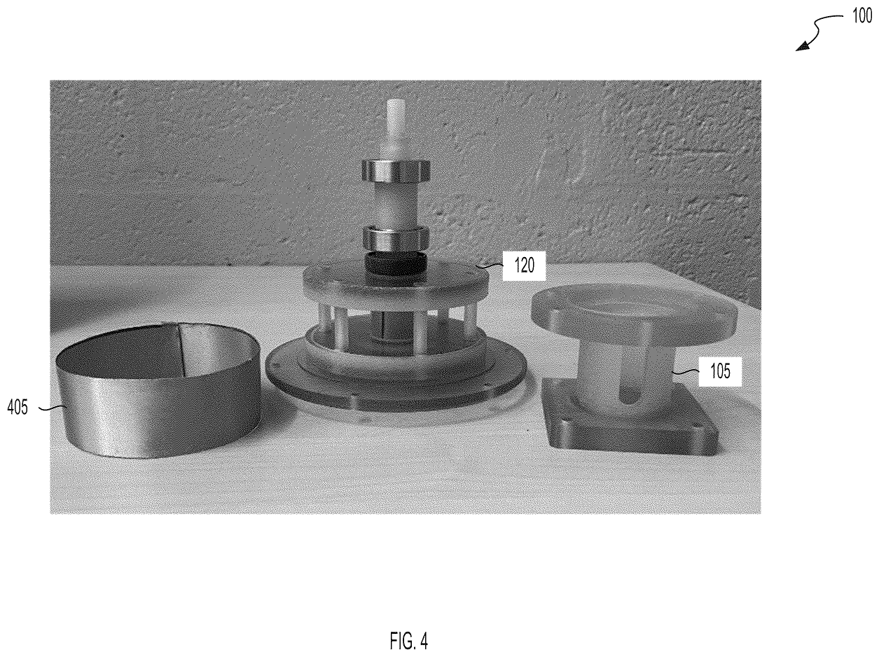

FIG. 4 is a view of a portion of the assembly 100. In this view, the assembly 100 is shown as disassembled (e.g., into component parts). The assembly 100 includes the housing 105. The assembly 100 includes the rotor 120. The rotor 120 is disposed in the housing 105. In this example, the assembly 100 is 3D printed.

The assembly 100 can include a barrier 405 (e.g., mesh barrier). In this example, the barrier 405 is disposed in the housing 105. The barrier 405 is configured to contain/enclose/house the adsorbent. For example, the barrier 405 can be arranged in a cylindrical shape to conform to the shape of the adsorbent. The barrier 405 can retain the adsorbent inside the rotor 120. The barrier 405 can rotate with the rotor 120. In some embodiments, the assembly 100 includes a monolithic porous packing (e.g., monolith) instead of mesh barrier. The monolith can include a single porous piece of material. The monolith can include loose adsorbent fused together to form a porous solid or a 3D printed porous solid substrate functionalized with different chelants.

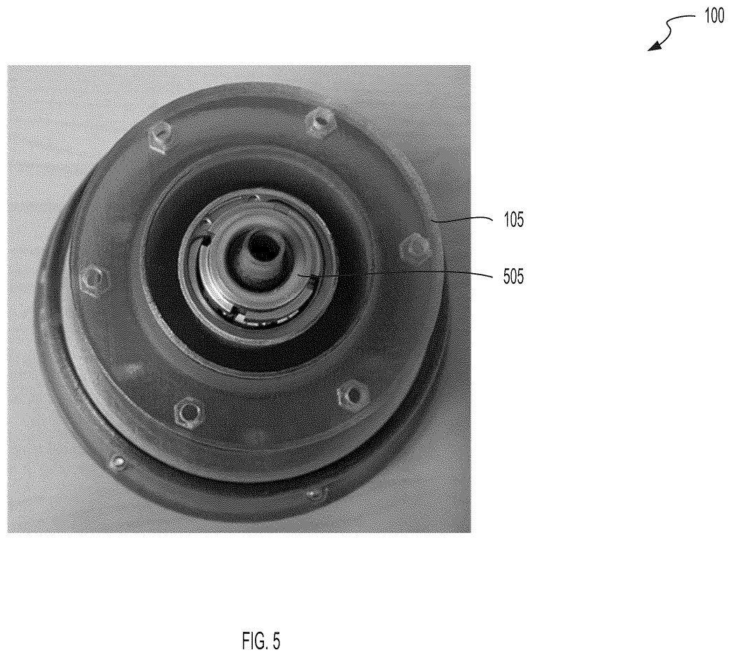

FIG. 5 is a bottom view of a portion of the assembly 100. The assembly 100 includes the housing 105. The assembly 100 can include a shaft seal 505. In this example, the shaft seal can couple the housing 105 with the rotor 120. The shaft seal 505 can keep the liquid 107 from leaking out of the housing 105, even under pressure. The assembly 100 can include one or more lock nuts, bearings, and/or seals. The shaft seal can allow the assembly 100 to withstand a back pressure within the unit.

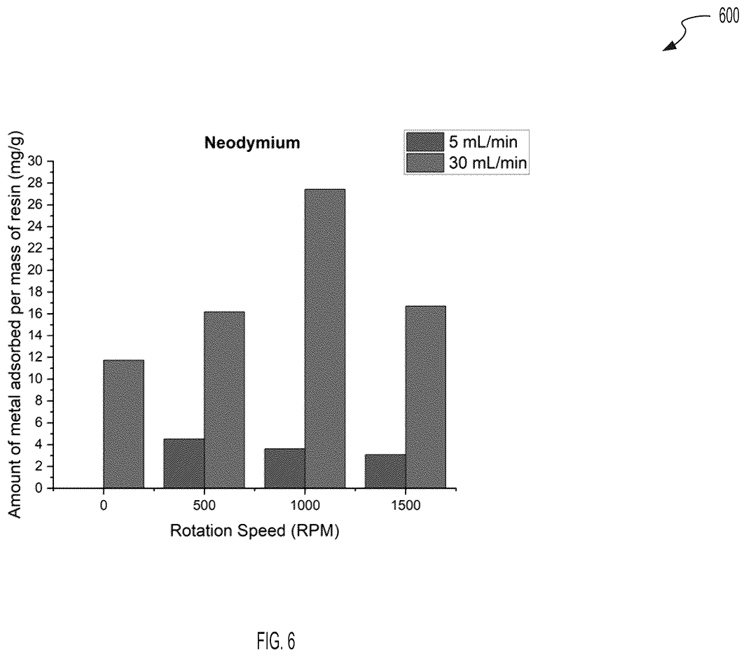

FIG. 6 illustrates a plot 600 of amount of neodymium (Nd) adsorbed vs. rotation speed. In this example, the amount of neodymium adsorbed per mass of resin (mg/g) is plotted against rotation speed (rotations per minute or rpm). The rotation speed is the rotation speed of the rotor 120. The liquid 107 flowed through the assembly 100 including a DGA resin was 3 M nitric acid (HNO₃) with 1000 ppm Nd, 600 ppm Ce, 400 ppm Mo, and 200 ppm Sr. Metal uptake from this liquid mixture was characterized at a variety of flow rates and rotational speeds. Changing the flow rate of the liquid 107 and/or the rotational speed of the rotor 120 can change the amount of metal retained on the adsorbent. The capacity of the resin for Nd at a flow rate of 30 mL/min and a rotational speed of 1000 rpm was more than double compared to a stationary column (0 rpm). The volumetric flow rate of 30 mL/min corresponds to a linear velocity of 5.88 mm/min through the assembly 100. The stationary column was a 2 mL column. The fluid flowing through the stationary column had a linear velocity of 5.88 mm/min. At a lower flow rate (e.g., 5 mL/min), there is little difference between the amount of neodymium retained on the adsorbent for various rotational speeds of the rotor 120. At a higher flow rate (e.g., 30 mL/min), the rotational speed of the rotor 120 can drastically affect the amount of neodymium retained on the adsorbent.

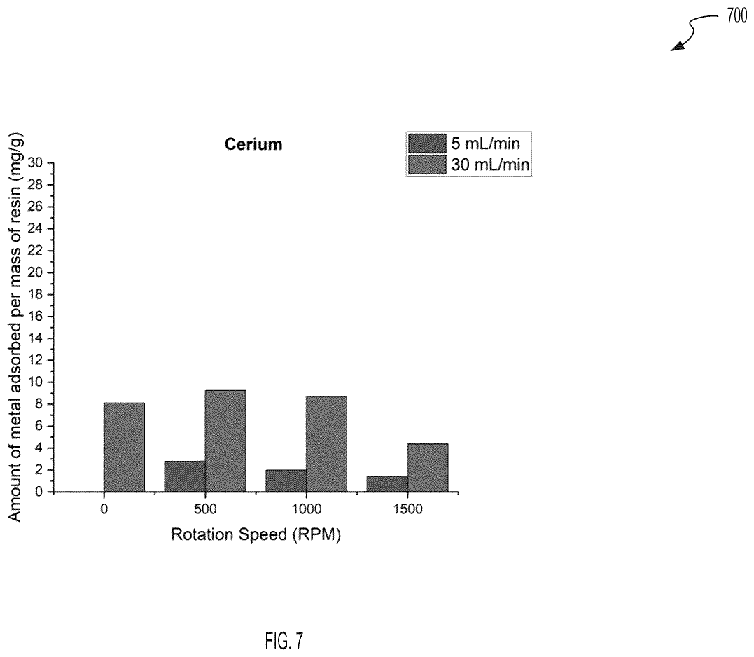

FIG. 7 illustrates a plot 700 of amount of cerium (Ce) adsorbed vs. rotation speed. In this example, the amount of cerium adsorbed per mass of resin (mg/g) is plotted against rotation speed (rotations per minute or rpm). The rotation speed is the rotation speed of the rotor 120. The liquid 107 flowed through the assembly 100 including a DGA resin was 3 M nitric acid (HNO₃) with 1000 ppm Nd, 600 ppm Ce, 400 ppm Mo, and 200 ppm Sr. Metal uptake from this liquid mixture was characterized at a variety of flow rates and rotational speeds. Changing the flow rate of the liquid 107 and/or the rotational speed of the rotor 120 can change the amount of metal retained on the adsorbent. Despite the increased loading of Nd as shown in FIG. 6, the Ce loading remained relatively constant and did not degrade under the competitive adsorption conditions tested. At a lower flow rate (e.g., 5 mL/min), there is little difference between the amount of cerium retained on the adsorbent for various rotational speeds of the rotor 120.

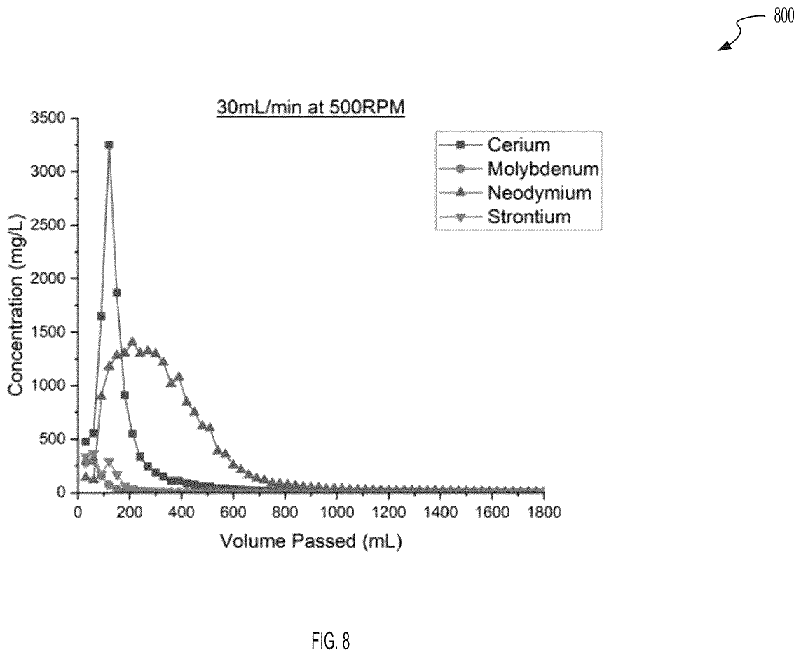

FIG. 8 illustrates a plot of an elution profile 800 of the assembly 100. In this example, the concentration of cerium, molybdenum, neodymium, and strontium (mg/L) is plotted against volume of liquid (e.g., liquid 107) passed (mL). The elution profile 800 was collected while stripping retained metals from the rotating packed bed using nitric acid with a pH of 2. The elution profile 800 from the rotating packed bed shows overlap between chemically similar rare earth metals. At a flow rate of 30 mL/min for the liquid 107 and 1000 rpm for the rotor 120, the purity of the Nd eluted from the RPB increased to 79% compared to 50% in the feed. The impurity in the Nd can result from overlap with the retained Ce. Good separation from Mo and Sr was observed. Changing the elution conditions, the flow rate of the liquid 107, and/or the rotational speed of the rotor 120 can change the amount of metal and/or purities of the metals eluted from the adsorbent. Different volume fractions of the liquid 107 can be collected. Each of the different volume fractions of the liquid 107 can have different concentrations of metals. The liquid 107 passed through the adsorbent to elute the metals from the adsorbent can have a defined concentration.

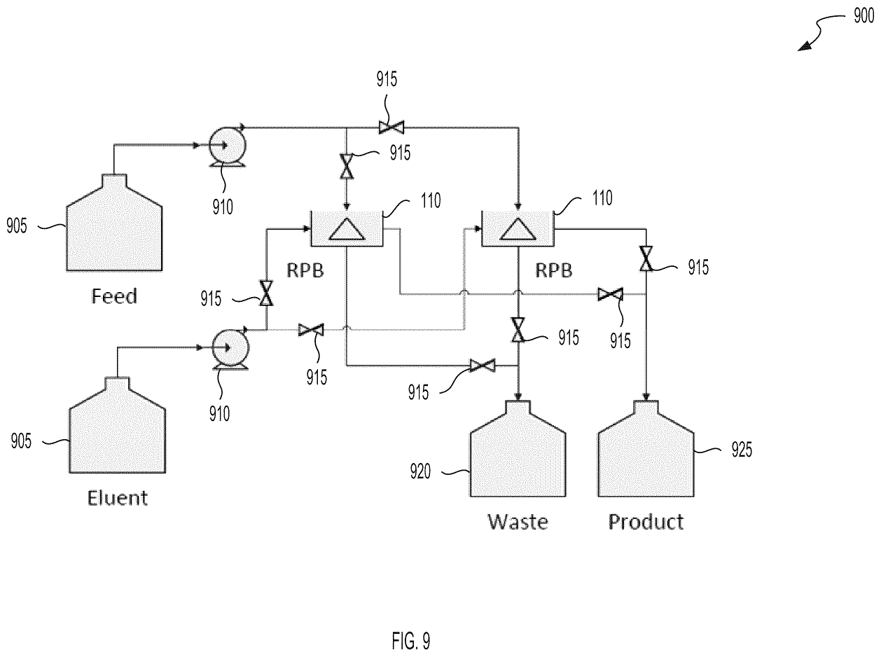

FIG. 9 illustrates a schematic diagram of an adsorption system 900. The adsorption system 900 can include one or more assemblies 100. In this example, the adsorption system 900 includes two feed tanks 905. The feed tank 905 can hold the liquid 107. One of the feed tanks 905 can hold a feedstock/processing stream. The other feed tank 905 (e.g., eluent tank) can hold an eluent. In this example, the adsorption system 900 includes one or more pumps 910. The pump 910 can pump the liquid 107 to the one or more assemblies 100. The pump 910 can be disposed between the feed tank 905 and the one or more assemblies 100. The adsorption system 900 can include one or more valves 915. The valve 915 can be disposed between the pump 910 and the one or more assemblies 100. In this example, the adsorption system 900 includes a product tank 920. The product tank 920 can receive a metal-containing feed. The metals received by the product tank 920 can include the metals adsorbed in the one or more assemblies 100. In this example, the adsorption system 900 includes a waste tank 925. The waste tank 925 can receive a waste feed. The valve 915 can be disposed between the one or more assemblies and the product tank 920. The valve 915 can be disposed between the one or more assemblies and the waste tank 925.

A method can include providing a housing. The housing can include an inlet and an outlet. In some embodiments, the housing includes two inlets and two outlets. The method can include disposing a rotor in the housing. The rotor can include an adsorbent. The method can include coupling the rotor to motor. The method can include flowing a first liquid including a first metal and a second metal. The first liquid can include a mixture of metals (e.g., two or more metals). The method can include rotating the rotor at a first rotational speed while flowing the first liquid through the adsorbent such that a first concentration of the first metal is adsorbed onto the adsorbent and a second concentration of the second metal is adsorbed onto the adsorbent. The method can include rotating the rotor at a second rotational speed while flowing a second liquid through the adsorbent such that a third concentration of the first metal is eluted from the adsorbent and a fourth concentration of the second metal is eluted from the adsorbent.

In some embodiments, the method can include flowing the first liquid through the adsorbent at a first flow rate. The method can include flowing the second liquid through the adsorbent at the first flow rate. In some embodiments, the method can include flowing the first liquid through the adsorbent at a first flow rate. The method can include flowing the second liquid through the adsorbent at a second flow rate different from the first flow rate. In some embodiments, the method can include flowing the first liquid from the inlet, through the adsorbent, and to the outlet. The method can include flowing the second liquid from the inlet, through the adsorbent, and to the outlet.

In some embodiments, the adsorbent can include a cross-linked polymer resin having ligands configured to chelate the first metal and the second metal. In some embodiments, the first liquid has a first pH, and the second liquid has a second pH different from the first pH.

No claim element herein is to be construed under the provisions of 35 U.S.C. § 112(f), unless the element is expressly recited using the phrase “means for.”

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

As used herein, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed:

1. An assembly, comprising:
a housing comprising an inlet and an outlet;
a rotor coupled with a motor and disposed in the housing, the rotor comprising an adsorbent,
wherein the rotor is configured to rotate at a first rotational speed and at a second rotational speed different from the first rotational speed,
wherein, at the first rotational speed, a first concentration of a first metal is adsorbed onto the adsorbent and a second concentration of a second metal is adsorbed onto the adsorbent,
wherein, at the second rotational speed, a third concentration of the first metal is adsorbed onto the adsorbent and a fourth concentration of the second metal is adsorbed onto the adsorbent, and
wherein the first concentration is different from the third concentration and the second concentration is different from the fourth concentration.

2. The assembly of claim 1, comprising:
a mesh barrier disposed in the housing and configured to contain the adsorbent.

3. The assembly of claim 1, wherein the adsorbent comprises a cross-linked polymer resin having ligands configured to chelate the first metal and the second metal.

4. The assembly of claim 1, comprising:
a shaft seal configured to couple the housing with the rotor.

5. The assembly of claim 1, wherein:
a liquid is configured to flow from the inlet, through the adsorbent, and to the outlet.

6. The assembly of claim 1, wherein:
a liquid is configured to elute the first metal and the second metal from the adsorbent.

7. The assembly of claim 1, wherein:
a first liquid having a first pH is configured to flow through the adsorbent such that the first metal and the second metal are adsorbed onto the adsorbent, and
a second liquid having a second pH different from the first pH is configured to flow through the adsorbent such that the first metal and the second metal are eluted from the adsorbent.

8. The assembly of claim 7, wherein:
the first liquid is configured to flow through the adsorbent when the rotor is rotating at the first rotational speed,
the rotor is configured to rotate at a third rotational speed different from the first rotational speed, and
the second liquid is configured to flow through the adsorbent when the rotor is rotating at the third rotational speed.

9. The assembly of claim 7, wherein:
the first liquid is configured to flow through the adsorbent when the rotor is rotating at the first rotational speed, and
the second liquid is configured to flow through the adsorbent when the rotor is rotating at the first rotational speed.

10. The assembly of claim 7, wherein:
the first liquid is configured to flow through the adsorbent a first flow rate, and
the second liquid is configured to flow through the adsorbent at the first flow rate.

11. The assembly of claim 7, wherein:
the first liquid is configured to flow through the adsorbent a first flow rate, and
the second liquid is configured to flow through the adsorbent at a second flow rate different from the first flow rate.

12. The assembly of claim 1, wherein the housing has a width of less than 3 ft.

13. The assembly of claim 1, wherein the adsorbent has a height of less than 1 ft.

14. The assembly of claim 1, wherein the first metal is neodymium and the second metal is cerium.

15. A method, comprising:
flowing a first liquid comprising a first metal and a second metal;
rotating a rotor, the rotor comprising an adsorbent and disposed in a housing having an inlet and outlet and the rotor being coupled to a motor, at a first rotational speed while flowing the first liquid through the adsorbent such that a first concentration of the first metal is adsorbed onto the adsorbent and a second concentration of the second metal is adsorbed onto the adsorbent; and
rotating the rotor at a second rotational speed while flowing a second liquid through the adsorbent such that a third concentration of the first metal is eluted from the adsorbent and a fourth concentration of the second metal is eluted from the adsorbent.

16. The method of claim 15, comprising:
flowing the first liquid through the adsorbent at a first flow rate; and
flowing the second liquid through the adsorbent at the first flow rate.

17. The method of claim 15, comprising:
flowing the first liquid through the adsorbent at a first flow rate; and
flowing the second liquid through the adsorbent at a second flow rate different from the first flow rate.

18. The method of claim 15, wherein:
the adsorbent comprises a cross-linked polymer resin having ligands configured to chelate the first metal and the second metal.

19. The method of claim 15, wherein:
the first liquid has a first pH, and
the second liquid has a second pH different from the first pH.

20. The method of claim 15, comprising:
flowing the first liquid from the inlet, through the adsorbent, and to the outlet; and
flowing the second liquid from the inlet, through the adsorbent, and to the outlet.
